(19) United States
(12) Patent Application Publication
(10) Pub. No.: US 2009/0001894 A1
(43) Pub. Date: Jan. 1, 2009

(54) METHOD FOR CALCULATING A DRIVING CURRENT OF A LIGHT SOURCE IN A SCREEN AND DISPLAY DEVICE THEREOF

(76) Inventor: Chie-Yao Hsu, Ping-Tung County (TW)

Correspondence Address: NORTH AMERICA INTELLECTUAL PROPERTY CORPORATION, P.O. BOX 506, MERRIFIELD, VA, 22116, US

(21) Appl. No.: 12/146,468

(22) Filed: Jun. 26, 2008

(30) Foreign Application Priority Data
Jun. 28, 2007 (TW) 096123487

(51) Int. Cl. H05B 37/02; H01J 40/14; G01J 1/32

(52) U.S. Cl. 315/157; 250/206; 250/205

(57) ABSTRACT

A method for calculating a driving current of a light source in a screen includes detecting a light signal of a displaying light emitted from the screen, and calculating the driving current of the light source according to the light signal.

### BACKGROUND OF THE INVENTION

1. Field of the Invention

The present invention relates to a method for calculating a driving current and a display device thereof, and more specifically, to a method for calculating a driving current of a light source in a screen and a display device thereof.

2. Description of the Prior Art

For a display device, such as a liquid crystal display device, brightness of light emitted from a light source is usually detected by a light sensor as a basis of brightness adjustment.

For a liquid crystal display device, light for displaying images is provided by a cold cathode fluorescent lamp disposed under a display panel. Thus, a common method for brightness adjustment is executed by means of a light sensor disposed near the cold cathode fluorescent lamp to detect brightness of light emitted from the cold cathode fluorescent lamp directly. Then, the related light signal information is transmitted to a microprocessor. At this time, if the microprocessor determines that brightness deviation or brightness decay happens in the cold cathode fluorescent lamp, a corresponding brightness adjustment is performed by the microprocessor. However, light emitted from the cold cathode fluorescent lamp needs to be made uniform and enhanced by other related components installed inside the liquid crystal display device, e.g. a backlight module, a brightness-enhanced film, a polarizer, etc., so that light with sufficient brightness can be emitted from the screen of the liquid crystal display device. Therefore, there is a certain difference between brightness of light emitted from the cold cathode fluorescent lamp and that emitted from the screen of the liquid crystal display device. In summary, the light sensor disposed near the cold cathode fluorescent lamp can detect brightness of light emitted from the cold cathode fluorescent lamp, but it cannot detect that emitted from the screen. As a result, the aforementioned method cannot precisely adjust brightness of light seen by a user.

### SUMMARY OF THE INVENTION

The present invention provides a method for calculating a driving current of a light source in a screen comprising: (a) detecting a light signal of a displaying light emitted from the screen; and (b) calculating the driving current of the light source according to the light signal detected in step (a).

The present invention further provides a display device capable of calculating driving current of light source, the display device comprising a light source; a screen having a light emitting side for receiving light transmitted from the light source and emitting a displaying light from the light emitting side; a light sensor disposed at the light emitting side for detecting a light signal of the displaying light emitted from the screen; and a calculating device electrically coupled to the screen and the light sensor comprising a driving current calculating device for calculating the driving current of the light source according to the light signal detected by the light sensor.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a display device according to the present invention.

FIG. 2 is a block diagram of the display device in FIG. 1.

FIG. 3 is a flowchart of a method for calculating the driving current of the light source according to the present invention.

### DETAILED DESCRIPTION

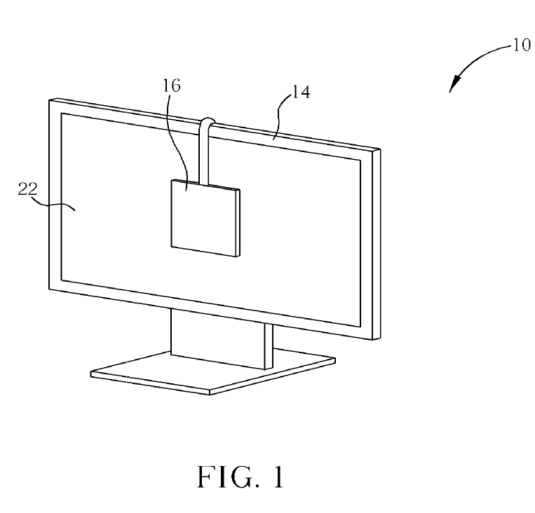

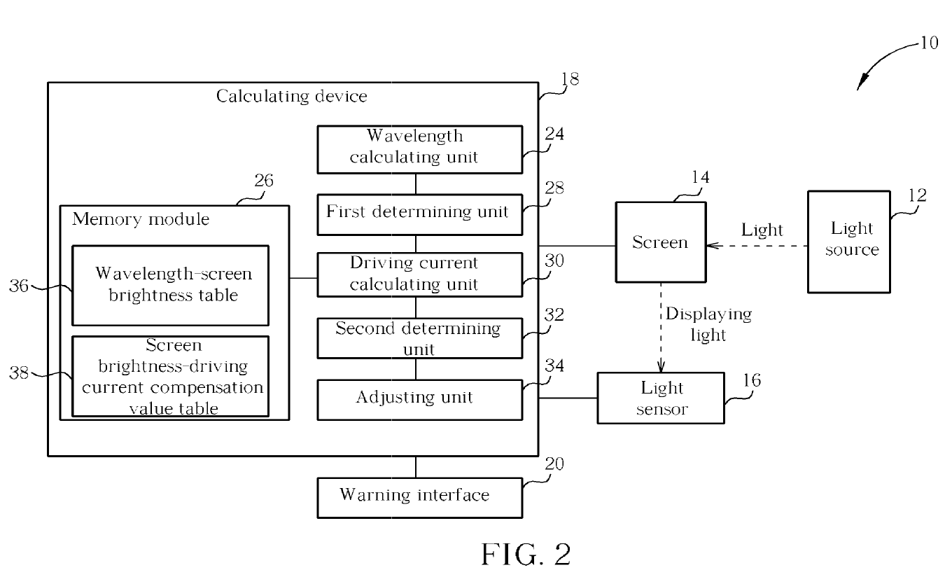

Please refer to FIG. 1 and FIG. 2. FIG. 1 is a diagram of a display device 10 according to the present invention. FIG. 2 is a block diagram of the display device 10 in FIG. 1. The display device 10 comprises a light source 12, a screen 14, a light sensor 16, a calculating device 18, and a warning interface 20. The screen 14 has a light emitting side 22. By other components installed inside the display device 10, light emitted from the light source 12 is uniformed and enhanced to form sufficient brightness and be emitted from the light emitting side 22 of the screen 14. The light sensor 16 is disposed at the light emitting side 22 of the screen 14. The light sensor 16 is used for detecting a light signal of a displaying light emitted from the light emitting side 22 of the screen 14. The light signal may be a square wave signal. The calculating device 18 is electrically coupled to the screen 14 and the light sensor 16. The calculating device 18 can be performed by hardware, software, or firmware. The calculating device 18 comprises a wavelength calculating unit 24, a memory module 26, a first determining unit 28, a driving current calculating unit 30, a second determining unit 32, and an adjusting unit 34. The wavelength calculating unit 24 calculates a wavelength of the light signal according to the light signal. The memory module 26 stores a wavelength-screen brightness table 36. The first determining unit 28 determines whether the wavelength of the light signal calculated by the wavelength calculating unit 24 is equal to a predetermined value, and the driving current calculating unit 30 calculates a driving current of the light source 12 according to the wavelength of the light signal calculated by the wavelength calculating unit 24 and the wavelength-screen brightness table 36 when the wavelength of the light signal is different from the predetermined value. Besides, the second determining unit 32 determines whether the driving current lies in a predetermined range and the warning interface 20 is electrically coupled to the calculating device 18. When the second determining unit 32 determines that the driving current lies outside the predetermined range, the warning interface 20 outputs a reminder to replace the light source 12. On the contrary, when the second determining unit 32 determines that the driving current lies in the predetermined range, the adjusting unit 34 drives the light source 12 according to the driving current. The light source 12 may be a fluorescent tube, such as a cold cathode fluorescent tube.

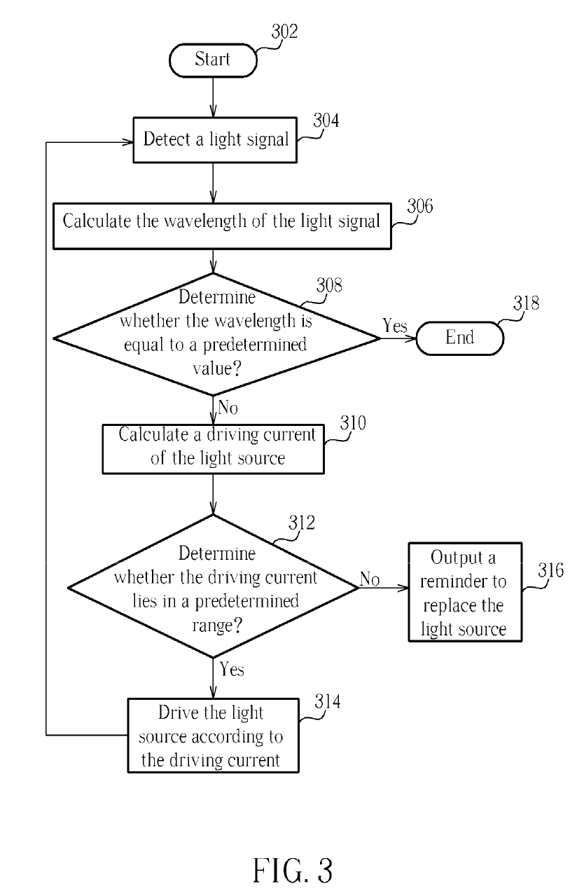

Please refer to FIG. 3. FIG. 3 is a flowchart of a method for calculating the driving current of the light source 12 according to the present invention. The method comprises the following steps:

Step 302: Start;

Step 304: The light sensor 16 detects the light signal of the displaying light emitted from the screen 14;

Step 306: The wavelength calculating unit 24 calculates the wavelength of the displaying light according to the light signal;

Step 308: The first determining unit 28 determines whether the wavelength is equal to the predetermined value. If so, go to Step 318; if not, go to Step 310;

Step 310: The driving current calculating unit 30 calculates the driving current of the light source 12 according to the wavelength and the wavelength-screen brightness table 36;

Step 312: The second determining unit 32 determines whether the driving current lies in the predetermined range. If so, go to Step 314; if not, go to Step 316;

Step 314: The adjusting unit 34 drives the light source 12 according to the driving current; go back to Step 304;

Step 316: The warning interface 20 outputs the reminder to replace the light source 12;

Step 318: End.

More detailed description for FIG. 3 is provided as follows. First, the wavelength can be estimated according to a period of the light signal of the displaying light. For example, assuming that the light signal detected by the light sensor 16 is a square wave signal, when the calculating device 18 receives the square wave signal detected and transmitted by the light sensor 16, the calculating device 18 stops every executing program except dealing with the square wave signal. At the same time, the wavelength calculating unit 24 in the calculating device 18 counts time between two adjacent negative edges (namely a whole waveform) of the square wave signal to obtain the period of the square wave signal. For a square wave signal, its wavelength is positively correlated with its period. Therefore, the wavelength of the square wave signal can be acquired according to the said period. Next, in Step 308, the first determining unit 28 determines whether the wavelength is equal to the predetermined value stored in the wavelength-screen brightness table 36. If the wavelength is not equal to the predetermined value, the driving current calculating unit 30 starts calculating the driving current for brightness adjustment (Step 310). For example, if an appropriated brightness scale of the normal display device is set as equal to 60, a wavelength corresponding to the brightness scale (60) can be found accordingly via the wavelength-screen brightness table 36, namely the predetermined value. After a long usage of the display device 10, when a user utilizes the light sensor 16 to perform a brightness adjustment, the first determining unit 28 determines whether the wavelength calculated by the wavelength calculating unit 24 is equal to the predetermined value. It is well-known in this art that the light wavelength is inversely proportional to light brightness. If the wavelength calculated by the wavelength calculating unit 24 is less than the predetermined value, it means that the brightness of light emitted from the screen 14 corresponding to the said brightness scale (60) is higher than that of the normal display device. Under this circumstance, reduction of the driving current of the light source 12 is required to decrease the brightness of light emitted from the screen 14. On the contrary, it means that the brightness of light emitted from the screen 14 corresponding to the said brightness scale (60) is insufficient. Under such circumstance, an increase in the driving current of the light source 12 is required to enhance the brightness of light emitted from the screen 14. In addition, if it is determined that the wavelength calculated by the wavelength calculating unit 24 is equal to the predetermined value, it means no brightness decay nor brightness deviation happens in the display device 10. Therefore, the brightness adjustment is finished herein.

It should be mentioned that it is not necessary to record each but one screen brightness scale (e.g. a default brightness scale) and its corresponding wavelength in the wavelength-screen brightness table 36. That is to say, if a default brightness scale of the display device 10 is equal to 60, the wavelength-screen brightness table 36 can record nothing but the default brightness scale (60) and its corresponding wavelength. If the brightness scale of the used display device 10 is set to 75 (not equal to 60) by the user, the display device 10 will be adjusted firstly till it met the default brightness scale (60). Subsequently, the corresponding wavelength can be measured and the brightness adjustment of the screen can be performed accordingly. After the brightness adjustment is done, the brightness scale of the used display device 10 is reset to the original value (75) as the user preferred.

Next, more detailed description for Step 310 is provided as follows. The memory module 26 can further store a screen brightness-driving current compensation value table 38. As a result, if the wavelength calculated by the wavelength calculating unit 24 is not equal to the predetermined value, a compensation value can be calculated by the driving current calculating unit 30 according to the wavelength calculated by the wavelength calculating unit 24, the wavelength-screen brightness table 36, and the screen brightness-driving current compensation value table 38. Thus, the driving current for brightness adjustment can be calculated by multiplying the compensation value by the original driving current before performing the brightness adjustment.

Finally, the predetermined range mentioned in Step 312 is determined based on a current range controllable by the calculating device 18. In general, the controllable current range of the calculating device 18 is from 0 A to 3.3 A. That is to say, when the second determining unit 32 determines that the driving current calculated by the driving current calculating unit 30 lies in the predetermined range, the adjusting unit 34 adjusts the driving current of the light source 12 according to the compensation value calculated by the driving current calculating unit 30, and subsequently drives the light source 12 according to the adjusted driving current. After the brightness adjustment of the screen 14 is executed, the light sensor 16 detects a light signal of a displaying light emitted from the screen 14, and transmits the detected light signal to the calculating unit 18. Then, the aforementioned calculating, determining, and adjusting sequences are performed repeatedly till the detected wavelength is equal to the wavelength recorded in the wavelength-screen brightness table 36. However, if the second determining unit 32 determines that the driving current calculated by the driving current calculating unit 32 lies outside the predetermined range, e.g. −0.1 A or 3.4 A, it means that the calculated driving current is out of control by the calculating unit 18. That is to say, the light source 12 is overused and the brightness of the light source 12 cannot be adjusted back to normal brightness. In this condition, the warning interface 20 outputs the reminder to the user to replace the light source 12.

The present invention utilizes a method for detecting a displaying light of the screen via a light sensor to correct brightness deviation or brightness decay. Compared with the prior art, which detects the brightness of light emitted from the cold cathode fluorescent lamp disposed under the display panel, the present invention detects the brightness of the displaying light emitted from the screen as a basis of the brightness adjustment and precisely adjust brightness of light seen by a user.

Those skilled in the art will readily observe that numerous modifications and alterations of the device and method may be made while retaining the teachings of the invention.

What is claimed is:

1. A method for calculating a driving current of a light source in a screen comprising:
(a) detecting a light signal of a displaying light emitted from the screen; and
(b) calculating the driving current of the light source according to the light signal detected in step (a).

2. The method of claim 1 further comprising calculating a wavelength of the light signal according to the light signal.

3. The method of claim 2, wherein calculating the wavelength of the light signal according to the light signal comprises estimating the wavelength of the light signal according to a period of the light signal.

4. The method of claim 2, wherein step (b) comprises calculating the driving current of the light source according to the wavelength of the light signal and a wavelength-to-screen brightness correlation.

5. The method of claim 4, wherein step (b) further comprises calculating a compensation value of the driving current of the light source according to a screen brightness-to-driving current compensation value correlation.

6. The method of claim 5 further comprising adjusting the driving current according to the compensation value when the driving current calculated in step (b) lies in a predetermined range.

7. The method of claim 2 further comprising determining whether the wavelength of the light signal is equal to a predetermined value.

8. The method of claim 7 further comprising performing step (b) when the wavelength of the light signal is different from the predetermined value.

9. The method of claim 1 further comprising determining whether the driving current calculated in step (b) lies in a predetermined range.

10. The method of claim 9 further comprising outputting a message of replacing the light source when the driving current lies outside the predetermined range.

11. The method of claim 9 further comprising driving the light source with the driving current when the driving current lies in the predetermined range.

12. A display device capable of calculating driving current of light source, the display device comprising:
a light source;
a screen having a light emitting side for receiving light transmitted from the light source and emitting a displaying light from the light emitting side;
a light sensor disposed at the light emitting side for detecting a light signal of the displaying light emitted from the screen; and
a calculating device electrically coupled to the screen and the light sensor comprising:
a driving current calculating device for calculating the driving current of the light source according to the light signal detected by the light sensor.

13. The display device of claim 12, wherein the calculating device further comprises a wavelength calculating unit for estimating a wavelength of the light signal according to a period of the light signal.

14. The display device of claim 13, wherein the calculating device further comprises a memory module for storing a wavelength-screen brightness table, and the driving current calculating unit calculates the driving current according to the wavelength of the light signal and the wavelength-screen brightness table.

15. The display device of claim 14, wherein the memory module further stores a screen brightness-driving current compensation value table, and the driving current calculating unit calculates a compensation value of the driving current according to the wavelength of the light signal, the wavelength-screen brightness table, and the screen brightness-driving current compensation value table.

16. The display device of claim 13, wherein the calculating unit further comprises a first determining unit for determining whether the wavelength of the light signal is equal to a predetermined value, and the driving current calculating unit calculates the driving current of the light source when the wavelength of the light signal is different from the predetermined value.

17. The display device of claim 15, wherein the calculating device further comprises a second determining unit for determining whether the driving current calculated by the driving current calculating unit lies in a predetermined range.

18. The display device of claim 17, wherein the calculating device further comprises an adjusting unit for adjusting the driving current according to the compensation value when the second determining unit determines that the driving current lies in the predetermined range.

19. The display device of claim 12, further comprising:
a second determining unit disposed in the calculating device, for determining whether the driving current calculated by the driving current calculating unit lies in a predetermined range; and
a warning interface electrically coupled to the calculating device for outputting a message of replacing the light source when the second determining unit determines that the driving current lies outside the predetermined range.

20. The display device of claim 12, wherein the calculating device further comprises:
a second determining unit for determining whether the driving current calculated by the driving current calculating unit lies in a predetermined range; and
an adjusting unit for driving the light source according to the driving current when the second determining unit determines that the driving current lies in the predetermined range.
